(19) United States
(12) Patent Application Publication
(10) Pub. No.: US 2021/0213862 A1
(43) Pub. Date: Jul. 15, 2021

(54) HEADREST

(71) Applicant: Udo BEIL, Wendelstein (DE)

(72) Inventor: Udo BEIL, Wendelstein (DE)

(21) Appl. No.: 17/119,397

(22) Filed: Dec. 11, 2020

(30) Foreign Application Priority Data
Jan. 13, 2020 (DE) 102020100571

(51) Int. Cl. B60N 2/865

(52) U.S. Cl. CPC B60N 2/865

(57) ABSTRACT

The invention relates to a headrest comprising a base (13) and a head-support part (16) having a guide assembly (18, 52) connected to the head-support part (16) and is connected to the base (13) that moves the head-support part (16) relative to the base (13) in a direction (x₁) toward the seat occupant's head and in the opposite direction (x₂) between a rear normal position and a frontmost extended position.

The invention relates to a headrest for a vehicle seat. A land vehicle, an aircraft or a watercraft may be a vehicle within the meaning of the invention.

A headrest of this kind is known from public prior use. The headrest has a base and a head-support part that is movable relative to the base in a positive or negative X direction, i.e. in a direction toward a seat occupant's head or in the opposite direction. The head-support part is mounted by racks retained on the headrest and pinions retained on the base part that are in engagement with the racks.

Furthermore, headrests are known from the prior art that comprise a base and a head-support part that is movable in the X direction, at least one column being fastened to the headrest and being guided in the X direction in a complementary cylindrically tubular guide on the base.

In both cases, a drawback of the above-mentioned prior art is that, in the rear position of the headrest, the head-support-side guide formations project relatively far backward, meaning that the headrest as a whole protrudes relatively far in the X direction.

The object of the invention is to provide a headrest that has a slim design in the X direction when the head-support part is in its rearmost position, i.e. when the head-support part is in a position in which it is closest to the base part.

The object is achieved by a headrest having the features of claim 1.

The headrest has a base. The base may be formed by a body mounted on a mount, such as supporting rods or a supporting-rod bracket, which body is mounted on the backrest of a vehicle seat by the mount. The base may e.g. be mounted on the backrest of the vehicle seat in a height-adjustable manner by the mount. Alternatively, the base is e.g. formed by the backrest structure itself. This may e.g. be the case in an integral seat, in which the base is part of the backrest structure.

Furthermore, the headrest has a head-support part. The head-support part is movable relative to the base in the direction of the seat occupant's head and in the opposite direction between a rear normal position and a frontmost extended position by a guide assembly connected to the head-support part and is connected to the base. The guide assembly mounts and guides the head-support part when moving between the normal position and the extended position.

The headrest is provided with a locking device that can lock the head-support part in at least one position of the movement between the normal position and the extended position. This means that the head-support part is lockable in the normal position and/or in the extended position and/or in at least one position between the normal position and the extended position.

According to the invention, the guide assembly has at least one first joint subassembly and at least one second joint subassembly. The joint subassemblies mount and guide the head-support part such that it only has degrees of freedom in a first direction toward the seat occupant's head and in a second, opposite direction. Each of the joint subassemblies has at least two links, a first link forming a first pivot with the base and a second link forming a second pivot with the head-support part. The first link and the second link together form a third pivot, axes of all the pivots of a joint subassembly being arranged in parallel.

In this way, the links of a joint subassembly can move between a folded position and an extended position, said links requiring very little space in the folded position. In the normal position, the links of each joint subassembly are arranged in the folded position, and in the extended position, the links are arranged in the extended position. The head-support part can therefore be positioned very close to the base in the normal position. For this reason, the headrest has a very slim design in a side view in the normal position. The axes of the pivots of the first joint subassembly and the axes of the pivots of the second joint subassembly approximately form a 90° angle.

In what is known as an integral seat, the backrest of the vehicle seat forms a closed surface that reaches beyond the driver's head region. A headrest protruding rearward in the x direction cannot be installed in the integral seat due to the installation space required for a headrest of this kind, since the integral seat increasingly tapers upward relative to the X direction, and therefore there is only a small amount of space available for a headrest comprising a head-support part that is adjustable in the X direction. By integrating a slim design in the solution according to the invention, this would also be flush with the backrest in the normal position, i.e. it would be suitable for the small installation space in an integral seat. In addition, according to the invention, the head-support part in the normal position on the head-support side would not differ from a conventional integral seat without an X-adjustable head-support part. The solution according to the invention is therefore also particularly suitable for an integral seat comprising a base that is part of a backrest structure or is rigidly connected thereto, and a head-support part that is movable relative to the base in the X direction.

The axes of the pivots of the first joint subassembly and the axes of the pivots of the second joint subassembly e.g. form a 90° angle with an axis that is parallel to the movement direction of the head-support part.

The length of the first link of the first joint subassembly and the length of the first link of the second joint subassembly may e.g. be identical or different. The length of the second link of the first joint subassembly and the length of the second link of the second joint subassembly may e.g. be identical or different. If the length of the link of the first joint subassembly differs from the length of the link of the second joint subassembly, a different angle can be formed between the links of the first joint subassembly and between the links of the second joint subassembly, according to the X position of the head-support part.

The first link and the second link of each joint subassembly e.g. form an angle, wherein the longitudinal axes of the links are in a folded position in the normal position and in an extended position in the extended position. In the normal position, the longitudinal axes are arranged in parallel with or approximately in parallel with one another. A very small angle, e.g. an angle of <5°, in particular 0°, is formed between the first link and the second link, for example. In this way, the guide assembly uses less installation space in the normal position. An angle of e.g. <180° is formed between the first link and the second link in the extended position.

According to an embodiment, the links have a flat design in one spatial dimension at right angles to the longitudinal axis of the links, such that the sandwich formed by two links in the folded position relative to an axis formed in parallel with the movement directions of the head-support part has a short extension. In this way, a construction that has a slim design in a side view can be ensured.

In order to prevent the longitudinal axes of the first link and the second link from forming a 180° angle with one another, the first link has a first stop formation and the second link has a second stop formation, the engagement of the stop formations defining a maximum angle of the links in the extended position. The maximum angle is e.g. less than 180°. In this way, the links cannot move into a 180° position, from which it could not be ensured that the third joint would fold inward and therefore move into the normal position.

According to an embodiment, the longitudinal axes of the links form a 180° angle in the extended position. In this case, a return spring between the links or a torsion spring in the joint between the first and the second link can assist said joint in folding inward and can ensure that it reliably moves from the extended position into the normal position.

The guide assembly e.g. has two first joint subassemblies and two second joint subassemblies. In this way, the two joint subassemblies can be arranged at different positions of the head-support part and the base part. This ensures reliable, smooth guidance.

In order to ensure smooth guidance, it is advantageous for the two first joint subassemblies and the two second joint subassemblies to be arranged at a distance from one another on the head-support part and the base.

In particular, the two first joint subassemblies are fastened to opposite ends relative to an extension of the head-support part in the Y direction and the two second joint subassemblies are fastened to opposite ends of the head-support part relative to an extension of the head-support part in the Z direction. This ensures particularly rectilinear, smooth guidance.

The locking device e.g. has at least one support assembly comprising at least one link, the link being arranged approximately in parallel with a plane spanned by the base in the normal position and forming an angle with the plane in the extended position. A first region of the link e.g. forms a joint with the base or the head-support part and a second region of the link e.g. being movably guided into different positions by a guide and being lockable in at least one position by a latch.

For example, the locking device has a first support on a first side of the head-support part and a second support on a side of the head-support part opposite the first side, each support comprising at least one link. In this way, forces acting on the head-support part take effect between the supports, such that tilting moments do not occur in the head-support part.

For example, one of the components of the base or head-support part forms a joint guide for the second region of the link, in which a projection of the link is guided on a track in two opposite track orientations. It is then possible to lock the projection in different positions by a latch, meaning that the head-support part is locked in place in the set position.

Embodiments of the invention are described by way of example in the following description of the figures, also with reference to the drawings. Here, for the sake of clarity, even if different embodiments are involved, identical or comparable parts or elements have been denoted by identical reference characters, sometimes with the addition of lower-case letters.

Features that are only described in relation to one embodiment can also be provided in any other embodiment of the invention within the scope of the invention. Even if they are not shown in the drawings, such amended embodiments are covered by the invention.

All the features disclosed are essential to the invention per se. The content of the disclosure of the associated priority documents (copy of the previous application) and the cited documents and the prior art devices described are hereby incorporated into the disclosure of the application in their entirety, also for the purpose of incorporating individual features or a plurality of features of these documents into one or more claims of the present application.

In the drawings:

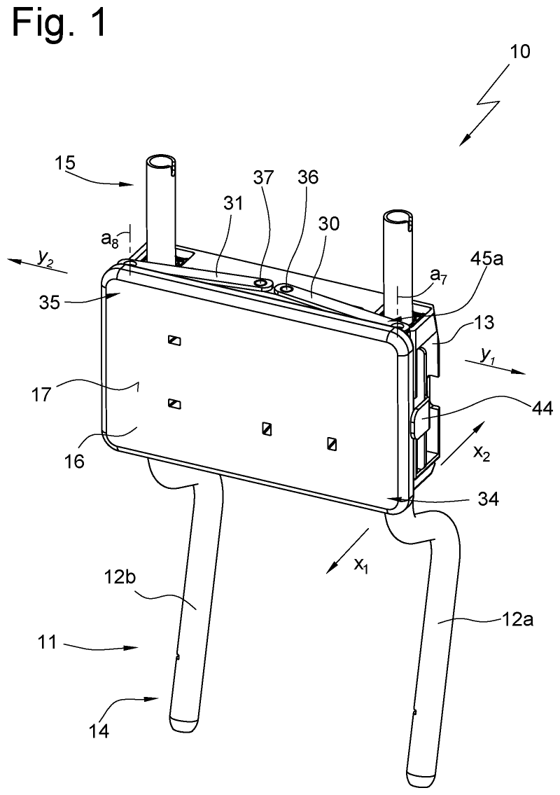

FIG. 1 is a perspective view of the headrest, with the head-support part being in a normal position,

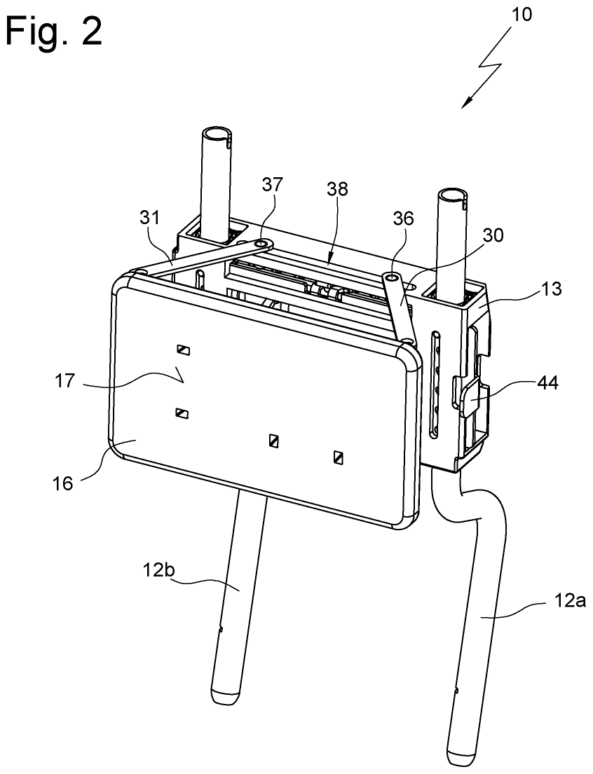

FIG. 2 is a perspective view of the headrest, with the head-support part being in an extended position,

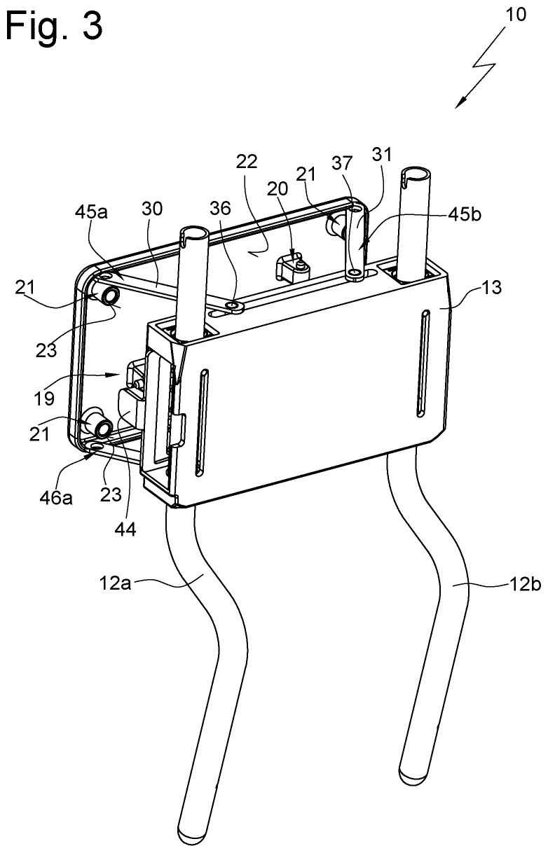

FIG. 3 is a perspective rear view of the headrest according to FIG. 2,

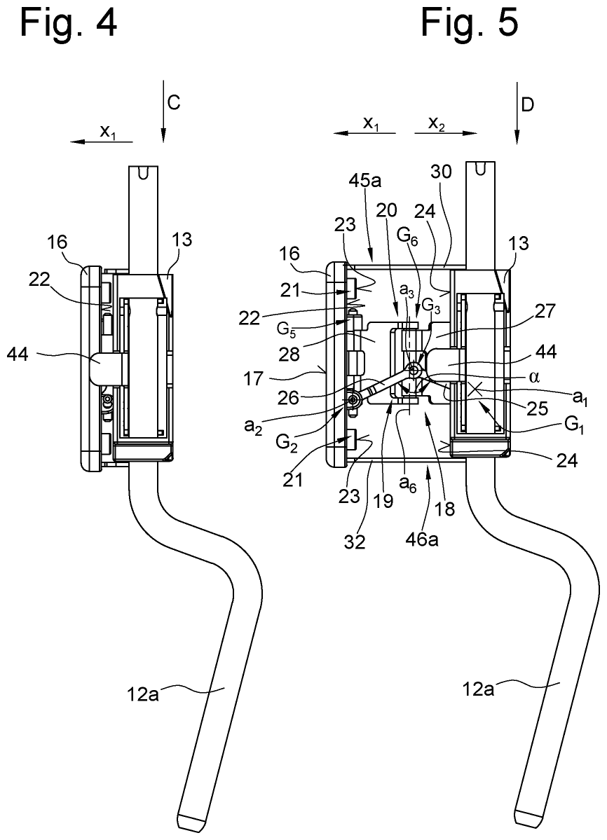

FIG. 4 is a side view of the headrest in the normal position,

FIG. 5 is a side view of the headrest in the extended position,

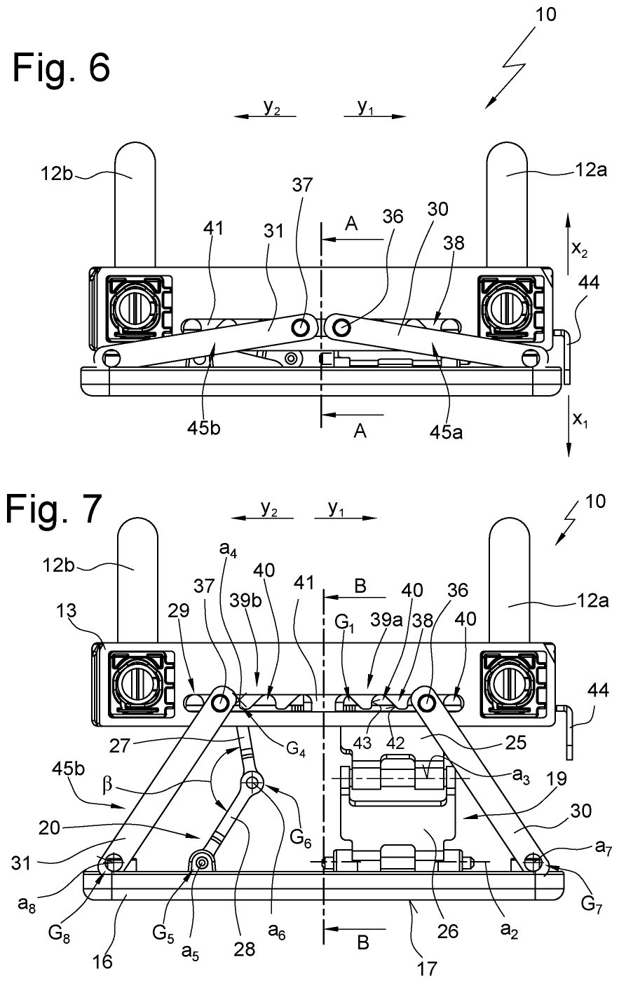

FIG. 6 is a plan view of the headrest from the direction of the arrow C in FIG. 4,

FIG. 7 is a plan view of the headrest from the direction of the arrow D in FIG. 5,

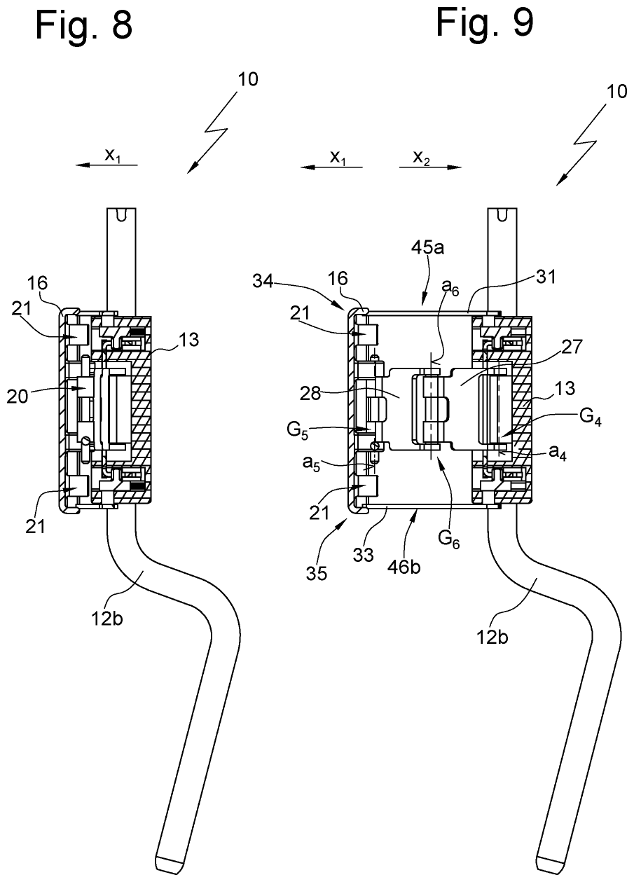

FIG. 8 is a sectional view along sectional line A-A in FIG. 6,

FIG. 9 is a sectional view along sectional line B-B in FIG. 7,

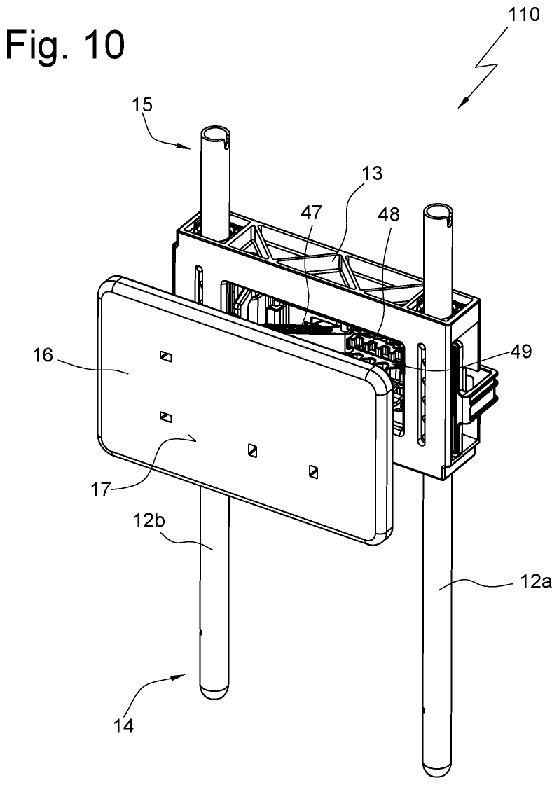

FIG. 10 is a perspective view of a second embodiment of the headrest according to the invention, with the head-support part being in the extended position,

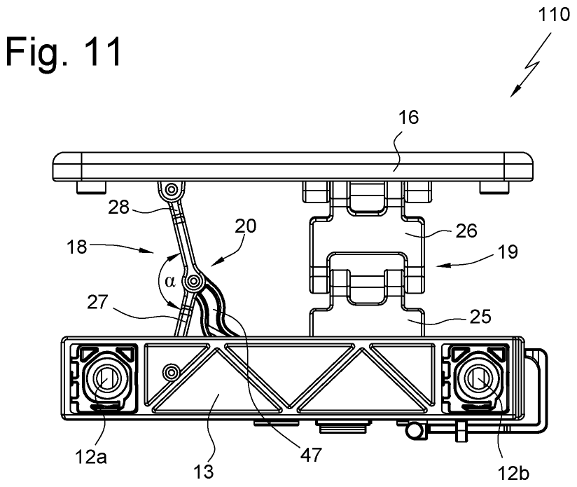

FIG. 11 is a plan view of the headrest according to FIG. 10,

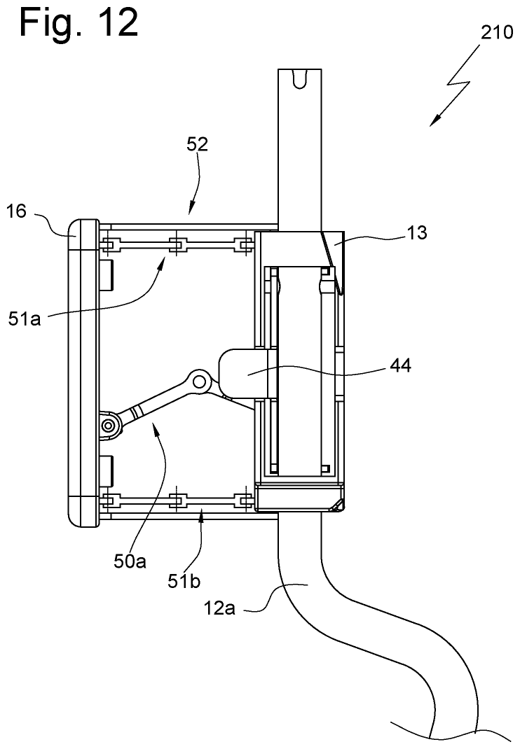

FIG. 12 is a side view of a third embodiment of the headrest according to the invention, with the head-support part being in the extended position,

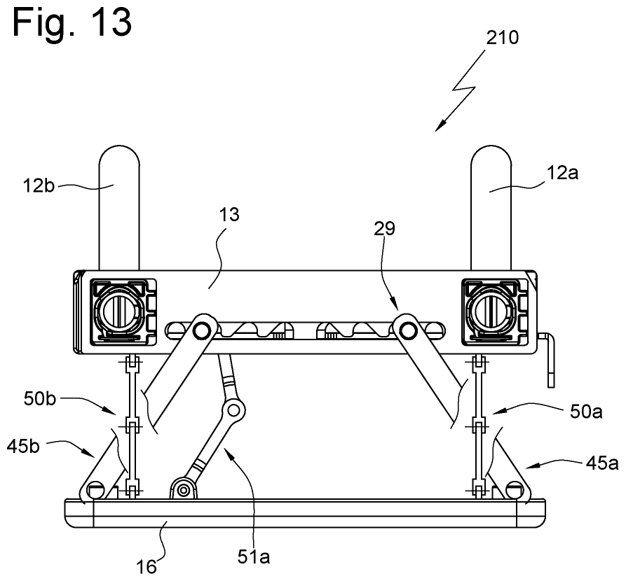

FIG. 13 is a plan view from the direction of the arrow E in FIG. 12.

The headrest as a whole is denoted by reference character 10 in the drawings.

For the sake of clarity, the headrest 10 is shown in the drawings without padding or a cover. In the present embodiment, the headrest 10 has a mount 11 that carries a base 13 of the headrest 10 on a vehicle seat. The mount 11 is not essential to the invention, however. The base 13 could alternatively also be directly connected to the vehicle seat or could be part of the vehicle seat. The mount 11 has supporting rods 12a and 12b, wherein a lower end 14 is provided for retaining in receptacles of a vehicle seat and an upper end 15 is provided for mounting the base 13. A head-support surface 17 is formed on a head-support part 16.

By means of a guide assembly 18 (not shown in FIG. 1), the head-support part 16 is moved between the normal position shown in FIG. 1, in which the head-support part 16 is moved backward on the base 13 as far as possible in the direction x₂, and an extended position, in which the head-support part 16 is moved forward as far as possible in the direction x₁. The extended position is shown in FIGS. 2 and 3. It can be seen that the head-support part 16 is at a greater distance from the base 13 in the extended position than in the normal position.

It can be seen in FIG. 3 that the head-support part 16 is provided with four pins 21 that project in the direction x₂ relative to a rear surface 22 of the head-support part 16. The pins 21 form a stop surface 23 in contact with an outer surface 24 (see FIG. 4) of the base 13 in the normal position of the head-support part 16. In this way, in the normal position, forces can additionally be transferred to the base 13 via the pins 21.

According to FIG. 5, the joint subassembly 19 has a first link 25 and a second link 26. The link 25 forms, together with the base 13, a pivot G₁ having a axis a₁, and the second link 26 forms, together with the head-support part 16, a pivot G₂ having a axis a₂. The links 25 and 26 together form a pivot G₃ having a axis a₃. The axes a₁, a₂ and a₃ are arranged in parallel with one another and in parallel with a y-axis (see FIGS. 5 to 9).

The joint subassembly 20 has a first link 27 and a second link 28. The link 27 forms, together with the base 13, a pivot G₄ having a axis a₄, and forms, together with the head-support part 16, a pivot G₅ having a axis a₅. The links 27 and 28 together form a pivot G₆ having a axis a₆. The axes a₄, a₅ and a₆ are arranged in parallel with one another and in parallel with a Z-axis.

Each of the axes a₁, a₂ and a₃ approximately forms a 90° angle relative to each of the axes a₄, a₅ and a₆. Depending on the elasticity of the construction and the material of the head-support part 16, the links 25, 26, 27 and 28, as well as the base, the angle may be up to ±10° greater or smaller.

The joint subassembly 19 makes it possible to move the head-support part 16 in the directions x₁ and x₂ and to rotate the head-support part 16 about the joints G₁, G₂ and G₃. The joint subassembly 20 makes it possible to move the head-support part 16 in the directions x₁ and x₂ and prevents the rotation about the joints G₁, G₂ and G₃. The head-support part 16 can therefore move only in the directions x₁ and x₂ with the joint axes 19 and 20, an angle α between the links 25 and 26 of the joint subassembly 19 and an angle β between the links 27 and 28 of the joint subassembly 20 being increased by the same amount when the head-support part 16 is moved in the direction x₁ and being decreased by the same amount when the head-support part is moved in the direction x₂. This is the case because the lengths of the links 25 and 26 of the joint subassembly 19 are the same as the lengths of the links 27 and 28 of the joint subassembly 20. If the lengths of the links of the joint subassembly 19 and the joint subassembly 20 are different, the angles and may be different.

In this embodiment, the joint subassembly 19 has a width extending in the y direction that is approximately a quarter of the width of the head-support part. The joint subassembly 20 has a height extending in the z direction that is approximately a third of the height of the head-support part 16. The extension of the joint subassembly 19 in the y direction and the joint subassembly 20 in the Z direction is only relevant when sufficient stability for transferring the moments absorbed by the head-support part 16 has to be ensured. In this context, according to an embodiment described below, two or more joint subassemblies 19 that are spaced from one another and two or more joint subassemblies 20 that are spaced from one another could alternatively be formed between the base 13 and the head-support part 16.

An angle α is formed between the links 25 and 26 of the joint subassembly 19 and an angle β is formed between the links 27 and 28 of the joint subassembly 20. The links 25 and 26 as well as the links 27 and 28 comprise stops that ensure that the angles remain less than 180°. This ensures that the joints always fold inward in the same direction and that the links are not arranged in a dead-center position. As explained above, the angles and/or could alternatively also be 180° in the extended position. In this case, a spring, for example, may load the links of the joint subassembly 19 and/or the joint subassembly 20 such that they are assisted when folding inward.

The headrest 10 has a locking device 29 for incrementally locking the head-support part in different x positions. It is noted at this point that the manner in which the locking device is formed is not the most important aspect of the invention. In the present embodiment, for locking the head-support part 16, the headrest 10 has a support 45a comprising two links 30 and 31 in an upper region 34 of the head-support part 16, and a support 45b comprising two links 32 and 33 in a lower region 35 of the head-support part 16.

The link 30 is mounted on the head-support part 16 at a first end so as to pivot about a axis a₇ of a pivot joint G₇. The link 31 is mounted on the head-support part 16 so as to pivot about a axis a₈ of a pivot joint G₈. At an end opposite the first end, the link 30 has a joint pin 36 and the link 31 has a joint pin 37. Both joint pins 36 and 37 are pivotally guided in a slot 38 and are movable in the directions y₁ and y₂.

A latch 41, comprising arrangements 39a and 39b of recesses 40, is movably mounted on the base 13. The latch 41 is loaded into a latched position in the direction x₁ by a return device (not shown). The latch 41 can be moved into a released position in the direction x₂ counter to the force of the return device. The joint pin 36 interacts with the arrangement 39a and can be locked in each of the recesses 40 in the arrangement 39a and the joint pin 39b interacts with the arrangement 39b and can be locked in each of the recesses 40 in the arrangement 39b.

When the head-support part 16 is moved out of the normal position according to FIG. 6 in the direction x₁ into the position according to FIG. 7, the joint pin 36 is moved in the direction y₁ and the joint pin 37 is moved in the direction y₂. Owing to the shape of the recesses that each have a sloped edge 42 and a steep edge 43, the head-support part 16 can be moved in the direction x₁ without the locking device 29 needing to be moved into the released position for this purpose. When a force is exerted on the head-support part 16 in the direction x₁, the joint pin 36 moves over the arrangement 39a and the joint pin 37 moves over the arrangement 39b, the sloped edge 42 causing the latch 41 to briefly move into the released position counter to the force of the return device in the direction x₂. However, it is not possible for the head-support part 16 to move in the direction x₂ without the latch 41 being moved into the released position by actuating a handle 44.

The support 45b is constructed in the same way as the support 45a, and will therefore not be discussed separately.

FIGS. 10 and 11 show a second embodiment of a headrest 110 according to the invention that only differs from the first configuration of the invention in that the locking device 49 merely has one support 47 in this case. At an end, the support 47 has a projection guided in a slot in the base in a manner that is not shown. The projection can be locked in different positions by a latch 48 using an arrangement of recesses.

A third embodiment of a headrest 210 according to the invention is shown in FIGS. 12 and 13. The headrest 210 differs from the first embodiment only in the configuration of the guide assembly 52. The guide assembly 52 has two first joint subassemblies 50a, 50b and two second joint subassemblies 51a and 51b. The joint subassemblies 50a and 50b are fastened to the head-support part 16 and the base part 13 at a distance from one another in the y direction. The joint subassemblies 51a and 51b are fastened to the head-support part 16 and the base part 13 at a distance from one another in the z direction.

It should be noted that the invention can also be used in the same way in headrests that are not mounted on a vehicle seat by supporting rods or a supporting-rod bracket. For example, in this case, the base is formed by a structure of the vehicle seat that is directly connected to the structure of the backrest or is formed in one piece with the structure of the backrest.

1. A headrest comprising:
a base; and
a head-support part; and
a guide assembly connected to the head-support part and to the base and allowing movement of the head-support part relative to the base in a direction toward a seat occupant's head and in an opposite direction between a rear normal position and a frontmost extended position.

2. The headrest according to claim 1, further comprising:
a locking device that can lock the head-support part in at least one position.

3. The headrest according to claim 1, wherein the guide assembly has at least one first joint subassembly and at least one second joint subassembly, each joint subassembly having at least a first link forming a first pivot with the base and a second link forming a second pivot with the head-support part, the first link and the second link together forming a third pivot, axes of all the pivots of each joint subassembly are parallel, the axes of the pivots of the first joint subassembly and the axes of the second joint subassembly approximately forming a 90° angle.

4. The headrest according to claim 3, wherein the axes of the third pivots of the first joint subassembly and the second joint subassembly form a 90° angle with an axis that is parallel to a movement direction of the head-support part.

5. The headrest according to any claim 3, wherein the first link and the second link of each joint subassembly form an angle and the links, in the normal position, are in a folded position and, in the extended position, are in an extended position.

6. The headrest according to claim 3 wherein the first link has a first stop formation and the second link has a second stop formation, and wherein in the extended position, the engagement of the stop formations defines a maximum angle of the links.

7. The headrest according to claim 6, wherein the maximum angle is <180°.

8. The headrest according to claim 1, wherein the guide assembly has two first joint subassemblies and two second joint subassemblies.

9. The headrest according to claim 8, wherein the two first joint subassemblies and the two second joint subassemblies are spaced from one another.

10. The headrest according to claim 8, wherein two first joint subassemblies are fastened to opposite ends relative to an extension of the head-support part in the Y direction, and the two second joint subassemblies are fastened to opposite ends of the head-support part relative to an extension of the head-support part in the Z direction.

11. The headrest according to claim 3, wherein the links have a flat design in one spatial dimension.

12. The headrest according to claim 2, wherein the locking device has at least one support assembly comprising at least one link that, in the normal position, is approximately parallel with a plane spanned by the base and, in the extended position, forms an angle with the plane, a first region of the one link forming a joint with the base or the head-support part and a second region of the link being movably guided into different positions by a guide and lockable in at least one position by a latch.

13. The headrest according to claim 12, wherein the locking device has a first support on a first side of the head-support part and a second support on an opposite side of the head-support part, each support having at least one link.

14. The headrest according to claim 12, wherein one of the components of base or head support part forms a joint guide for the second region of the link, in which a projection of the link is guided on a track in two opposite track orientations.
